(19) United States
(12) Patent Application Publication
(10) Pub. No.: US 2026/0268917 A1
(43) Pub. Date: Sep. 10, 2026

(54) METHOD, APPARATUS, DEVICE, AND STORAGE MEDIUM FOR AUDIO ENCODING

(71) Applicants: Beijing Zitiao Network Technology Co., Ltd., Beijing (CN); Bytedance Technology Ltd., Grand Cayman (KY)

(72) Inventors: Xiaobin Zhuang, Beijing (CN); Zhuo Chen, Los Angeles, CA (US); Yuping Wang, Beijing (CN); Yuxuan Wang, Los Angeles, CA (US)

(21) Appl. No.: 19/542,617

(22) Filed: Feb. 17, 2026

(30) Foreign Application Priority Data
Feb. 18, 2025 (CN) 202510179935.9

(51) Int. Cl. G10L 19/22; G10L 19/018

(52) U.S. Cl. CPC G10L 19/22; G10L 19/018

(57) ABSTRACT

A method and an apparatus, a device, and a storage medium for audio encoding are provided. The method includes: obtaining audio content; processing the audio content using an audio encoder to determine a target mean representation and a target variance representation; and generating an encoding representation of the audio content based on the target mean representation and the target variance representation, where the audio encoder is trained based on a process including: processing sample audio using the audio encoder to determine a sample mean representation; determining a semantic loss based on the sample mean representation and a reference semantic feature of the sample audio; and determining a training loss of the audio encoder based on the semantic loss, to train the audio encoder.

### CROSS-REFERENCE

The present application claims priority to Chinese Patent Application No. 202510179935.9, filed on Feb. 18, 2025, and entitled “METHOD, APPARATUS, DEVICE AND MEDIUM FOR AUDIO ENCODING”, the entirety of which is incorporated herein by reference.

### TECHNICAL FIELD

Example embodiments of the present disclosure generally relate to the field of computers, and in particular, to a method, an apparatus, a device, and a computer-readable storage medium for audio encoding.

### BACKGROUND

With the rapid development of computer technology, an audio generation technology implemented based on a machine learning model may be applied to synthesis of audio such as speech, music, and sound effects for use in scenarios such as film and television production, game development, advertisement creation, virtual reality, and augmented reality. The audio generation technology may be divided into two parts: audio encoding and audio restoration. The quality of an encoding feature generated in an encoding process plays a key role in the quality of audio generated based on the encoding feature. Step-by-step optimization of the machine learning model used for audio encoding may help improve the quality of the audio generated based on the encoding feature.

### SUMMARY

In a first aspect of the present disclosure, a method for generating audio is provided. The method includes: obtaining audio content; processing the audio content using an audio encoder to determine a target mean representation and a target variance representation; and generating an encoding representation of the audio content based on the target mean representation and the target variance representation, where the audio encoder is trained based on a process including: processing sample audio using the audio encoder to determine a sample mean representation; determining a semantic loss based on the sample mean representation and a reference semantic feature of the sample audio; and determining a training loss of the audio encoder based on the semantic loss, to train the audio encoder.

In a second aspect of the present disclosure, an apparatus for generating audio is provided. The apparatus includes: an obtaining module configured to obtain audio content; a determination module configured to process the audio content using an audio encoder to determine a target mean representation and a target variance representation; and a generation module configured to generate an encoding representation of the audio content based on the target mean representation and the target variance representation, where the audio encoder is trained based on a process including: processing sample audio using the audio encoder to determine a sample mean representation; determining a semantic loss based on the sample mean representation and a reference semantic feature of the sample audio; and determining a training loss of the audio encoder based on the semantic loss, to train the audio encoder.

In a third aspect of the present disclosure, a computing device is provided. The device includes at least one processing unit; and at least one memory coupled to the at least one processing unit and storing instructions for execution by the at least one processing unit, the instructions, when executed by the at least one processing unit, causing the device to perform the method of the first aspect.

In a fourth aspect of the present disclosure, a computer-readable storage medium is provided. The computer-readable storage medium stores a computer program executable by a processor to implement the method of the first aspect.

It should be understood that content described in this summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements.

FIG. 1 is a schematic diagram of an example environment in which an embodiment according to the present disclosure may be implemented;

FIG. 2 is a flowchart of an example process for audio encoding according to some embodiments of the present disclosure;

FIG. 3 is a flowchart of an example process for training an audio encoder according to some embodiments of the present disclosure;

FIG. 4 is a block diagram of the example process for training the audio encoder according to some embodiments of the present disclosure;

FIG. 5 is a flowchart of an example process for training a semantic encoding model according to some embodiments of the present disclosure;

FIG. 6 is a block diagram of the example process for training the semantic encoding model according to some embodiments of the present disclosure;

FIG. 7 is a schematic block diagram of an example apparatus for audio encoding according to some embodiments of the present disclosure; and

FIG. 8 is a block diagram of an electronic device capable of implementing a plurality of embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for more thorough and complete understanding of the present disclosure. It should be understood that the drawings and the embodiments of the present disclosure are only for illustrative purposes and are not intended to limit the scope of protection of the present disclosure.

It should be noted that titles of any sections/subsections provided herein are not restrictive. Various embodiments are described throughout this specification, and any type of embodiment may be included under any section/subsection. In addition, the embodiments described in any section/subsection may be combined with any other embodiments described in the same section/subsection and/or different sections/subsections in any manner.

In the description of the embodiments of the present disclosure, the term “include/comprise” and similar terms thereof should be understood as open-ended inclusions, that is, “include/comprise but not limited to”. The term “based on” should be understood as “at least partially based on”. The term “one embodiment” or “this embodiment” should be understood as “at least one embodiment”. The term “some embodiments” should be understood as “at least some embodiments”. Other definitions, either explicit or implicit, may be included below. The terms “first”, “second”, and the like may refer to different or same objects. Other definitions, either explicit or implicit, may be included below.

The embodiments of the present disclosure may involve user data, data acquisition, and/or data use. These aspects comply with corresponding laws, regulations, and related provisions. In the embodiments of the present disclosure, all data collection, acquisition, processing, handling, forwarding, use, and the like are performed on the premise that the user is aware of and confirms. Accordingly, when implementing the embodiments of the present disclosure, the user should be informed of the type, range of use, use scenarios, etc., of data or information that may be involved and the authorization of the user should be obtained in an appropriate manner in accordance with relevant laws and regulations. A specific manner of informing and/or authorizing may be changed according to the actual situation and application scenarios, and the scope of the present disclosure is not limited in this regard.

If the solutions in this specification and the embodiments involve personal information processing, the processing is performed on the premise that there is a legal basis (for example, the consent of the personal information subject is obtained, or it is necessary for contract performance, etc.), and the processing is performed only within a specified or agreed scope. If the user refuses to process personal information other than necessary information required for the basic function, it does not affect the user's use of the basic function.

As mentioned above, the audio generation technology implemented based on the machine learning model may be used for synthesis of audio such as speech, music, and sound effects. The audio generation technology may be divided into two parts: audio encoding and audio restoration. The quality of an encoding feature generated in an encoding process plays a key role in the quality of audio generated based on the encoding feature. There are mainly two traditional schemes for generating audio based on audio encoding and audio restoration. The first is to use an audio encoder to generate a Mel spectrogram, and then use a neural network as an audio decoder and a vocoder and process the Mel spectrogram in turn to generate the required audio. The second is to use a variational autoencoder to process the Mel spectrogram to obtain an audio representation, and then input the audio representation into the audio decoder and the vocoder to generate the required audio. The audio generated by the above two schemes has the problem of unbalanced sound quality in each frequency band.

The embodiments of the present disclosure propose a scheme for audio encoding. The scheme includes: obtaining audio content; processing the audio content using an audio encoder to determine a target mean representation and a target variance representation; and generating an encoding representation of the audio content based on the target mean representation and the target variance representation, where the audio encoder is trained based on a process including: processing sample audio using the audio encoder to determine a sample mean representation; determining a semantic loss based on the sample mean representation and a reference semantic feature of the sample audio; and determining a training loss of the audio encoder based on the semantic loss, to train the audio encoder.

In this way, the embodiments of the present disclosure may generate an encoding representation with semantic constraints, so that the audio generated by multiple encoding representations with the same semantics is also relatively close, which may help improve the quality of the audio generated based on the encoding feature.

Various example implementations of the scheme are described in detail below with further reference to the drawings.

### Example Environment

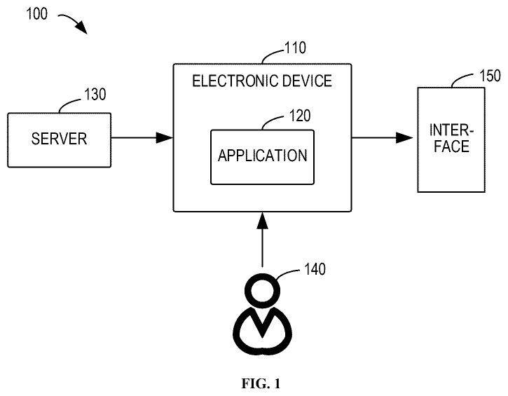

FIG. 1 is a schematic diagram of an example environment 100 in which the embodiments of the present disclosure may be implemented. As shown in FIG. 1, the example environment 100 may include an electronic device 110.

In the example environment 100, the electronic device 110 may run an application 120 supporting audio encoding. The application 120 may be any appropriate type of application for audio encoding, and examples thereof may include but are not limited to: an audio processing application or other appropriate applications. A user 140 may interact with the application 120 via the electronic device 110 and/or its attached device.

In the environment 100 of FIG. 1, if the application 120 is active, the electronic device 110 may present an interface 150 for supporting audio encoding through the application 120.

In some embodiments, the electronic device 110 communicates with the server 130 to enable provision of services of the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination thereof, including accessories and peripherals of these devices, or any combination thereof. In some embodiments, the electronic device 110 may also support any type of interface for the user 140 (such as “wearable” circuitry, etc.).

The server 130 may be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide a backend service for the application 120 supporting audio encoding in the electronic device 110.

A communication connection may be established between the server 130 and the electronic device 110. The communication connection may be established in a wired or wireless manner. The communication connection may include but is not limited to a Bluetooth connection, a mobile network connection, a universal serial bus (USB) connection, a wireless fidelity (WiFi) connection, etc., and the embodiments of the present disclosure are not limited in this regard. In the embodiments of the present disclosure, the server 130 and the electronic device 110 may implement signaling interaction through the communication connection therebetween.

It should be understood that the structures and functions of the elements in the environment 100 are described for illustrative purposes only, without suggesting any limitation to the scope of the present disclosure.

Some example embodiments of the present disclosure are described below with continued reference to the drawings.

### Example Process

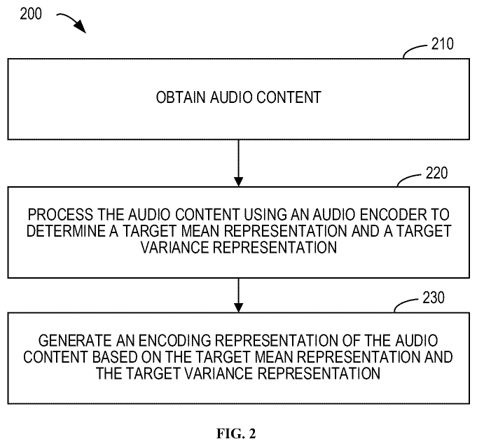

FIG. 2 is a flowchart of an example process 200 for audio encoding according to some embodiments of the present disclosure. The process 200 may be implemented at the electronic device 110. The process 200 is described below with reference to FIG. 1.

As shown in FIG. 2, at block 210, the electronic device 110 obtains audio content.

In some embodiments, the audio content is audio to be encoded, which may include at least one of speech, music, and sound effects. As an example, the electronic device 110 may obtain the audio content through a voice input device such as a recorder or a microphone.

At block 220, the electronic device 110 processes the audio content using an audio encoder 420 to determine a target mean representation and a target variance representation.

In some embodiments, the audio encoder 420 may map input high-dimensional audio data to a low-dimensional latent space and generate a corresponding latent representation to facilitate subsequent processing. Herein, the audio content is the high-dimensional audio data. Correspondingly, the low-dimensional latent representation corresponding to the audio content may be described by the target mean representation and the target variance representation. Specifically, the mapping process is to map a Gaussian distribution of each frame of the audio content to the same Gaussian distribution. The “same Gaussian distribution” mentioned here is similar to a Gaussian distribution. The target mean representation is a mean representation of the “same Gaussian distribution”, and the target variance representation is a variance representation of the “same Gaussian distribution”.

Additionally, to determine the target mean representation and the target variance representation, the electronic device 110 may set a mapping layer 430 connected to an output end of the audio encoder 420.

At block 230, the electronic device 110 generates an encoding representation of the audio content based on the target mean representation and the target variance representation.

In some embodiments, the encoding representation may be obtained by resampling the target mean representation and the target variance representation. The encoding representation may be further processed to generate audio. Specifically, corresponding audio may be generated according to a scenario in which the required audio is applied, to apply to the corresponding scenario. Compared with the audio content, the generated audio may include richer content. For example, the generated audio may be a dialogue in a specific scenario, a song added with sound effects, or music added with musical instruments such as a guitar and a drum.

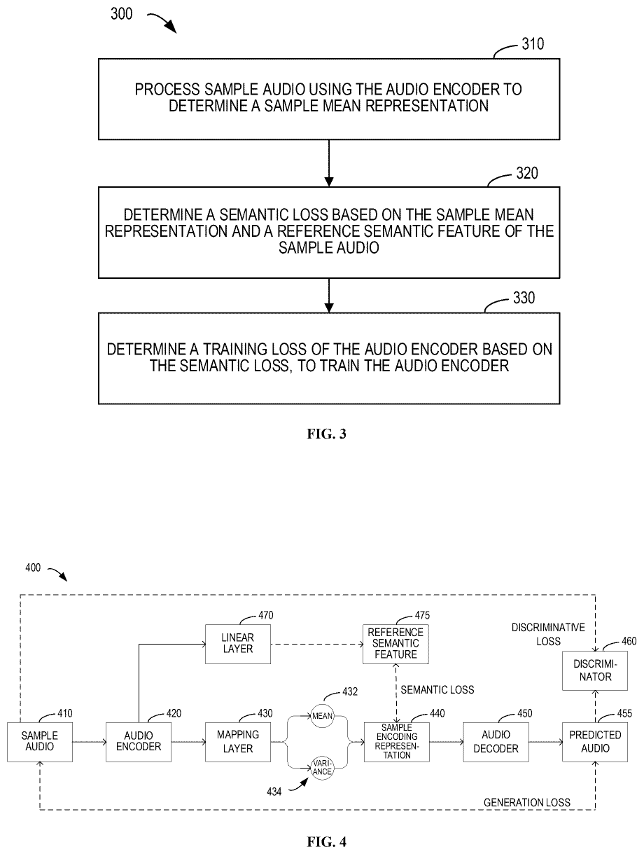

The specific process of training the audio encoder 420 is described below with reference to FIG. 3 and FIG. 4. FIG. 3 is a flowchart of an example process 300 of training the audio encoder 420 according to some embodiments of the present disclosure. FIG. 4 is a block diagram of the example process 400 of training the audio encoder 420 according to some embodiments of the present disclosure. The process 300/process 400 may be performed by an appropriate electronic device, such as the electronic device 110 or the server 130. The process 300 is described below with reference to FIG. 1 and FIG. 4 by using the server 130 as an example.

As shown in FIG. 3, at block 310, the server 130 processes sample audio 410 using the audio encoder 420 to determine a sample variance representation 434 and a sample mean representation 432.

In some embodiments, the sample audio 410 may include at least one of speech, music, and sound effects.

In some embodiments, the sample audio 410 may also be presented in the form of a tensor. As an example, a tensor of the sample audio 410 of one second may be [1, t1]. Herein, t1 may be related to, for example, the duration and sampling rate of the sample audio 410. In a specific example, the sample audio 410 is audio with a sampling rate of 32000 in one second. In this case, the dimension of the sample audio 410 is [1, 32000].

It should be understood that the audio encoder 420 may map the input high-dimensional audio data to the low-dimensional latent space and generate the corresponding latent representation to facilitate subsequent processing. Specifically, the audio encoder 420 may map a Gaussian distribution of each frame of the input high-dimensional audio data to the same Gaussian distribution. For ease of description, the “same Gaussian distribution” mentioned above is referred to as a reference Gaussian distribution herein. The reference Gaussian distribution is similar to a Gaussian distribution.

When the server 130 uses the audio encoder 420 to process the sample audio 410, the sample mean representation 432 and the sample variance representation 434 output by the audio encoder 420 are a mean and a variance of the reference Gaussian distribution. As an example, when the sample audio 410 is represented by a tensor, a tensor corresponding to the sample mean representation 432 and a tensor corresponding to the sample variance representation 434 are both [t2, d], where t2 is much smaller than t1. In a specific example, the sample audio 410 is audio with a sampling rate of 32000 in one second. In this case, tensors corresponding to the sample mean representation 432 and the sample variance representation 434 are [32, 64].

At block 320, the server 130 determines a semantic loss based on the sample mean representation 432 and a reference semantic feature 475 of the sample audio 410. The semantic loss indicates the similarity between the mean representation and the reference semantic feature 475.

In some embodiments, the reference semantic feature 475 may be generated by the server 130 using a semantic encoding model 620 to process the sample audio 410, which may indicate attribute information of the sample audio 410. As an example, the attribute information may be a preset object that generates the audio content or an action of the preset object. The preset object may be, for example, a human, a bird, or an object. The action of the preset object may be, for example, a human cry, human speech, a bird chirping, a drumming sound, etc.

The server 130 compares the sample mean representation 432 with the reference semantic feature 475, which may add semantic constraints to the sample mean representation 432, so that target mean representations generated by the audio encoder 420 when processing different audios with the same attribute information are similar.

In some embodiments, the semantic encoding model 620 for generating the reference semantic feature 475 may include a reference encoder 625.

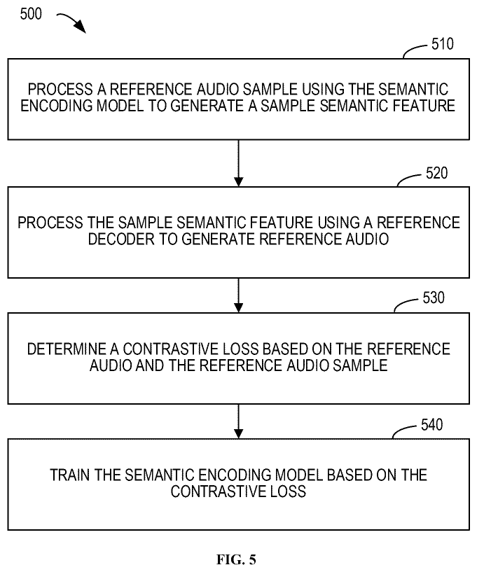

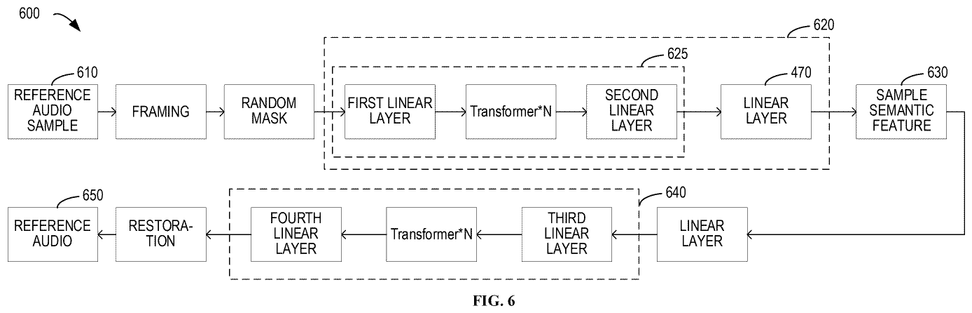

The specific process of training the semantic encoding model 620 is described below with reference to FIG. 5 and FIG. 6. FIG. 5 is a flowchart of an example process 500 of training the semantic encoding model 620 according to some embodiments of the present disclosure. FIG. 6 is a block diagram of the example process 600 of training the semantic encoding model 620 according to some embodiments of the present disclosure. The process 500/process 600 may be performed by an appropriate electronic device, such as the server 130. The process 500 is described below with reference to FIG. 1 and FIG. 6.

As shown in FIG. 5, at block 510, the server 130 processes a reference audio sample 610 using the reference encoder 625 to generate a sample semantic feature 630.

In some embodiments, the reference audio sample 610 may include at least one of speech, music, and sound effects, which may be presented in the form of a tensor.

In some embodiments, before processing the reference audio sample 610 using the reference encoder 625, the server 130 may further preprocess the reference audio sample 610, so that the reference encoder 625 may have a stronger recognition capability. That is, the server 130 may preprocess the reference audio sample 610 to generate a target audio sample; and then process the target audio sample using the reference encoder 625 to generate the sample semantic feature 630.

As an example, the preprocessing performed by the server 130 on the reference audio sample 610 may be adding a random mask to the reference audio sample 610 and/or splitting the reference audio sample 610.

In a specific example, when the server 130 applies a mask to the reference audio sample 610, the target audio sample is generated. The mask may indicate that at least one segment of the reference audio sample is set to preset content. The preset content may be, for example, noise.

In a specific example, when the server 130 splits the reference audio sample 610, multiple target audio samples are generated. In this case, the server 130 may use the semantic encoding model 620 to process each of the multiple target audio samples in turn. The server 130 may split the reference audio sample 610 by frames, for example.

In another specific example, the server 130 may first split the reference audio sample 610 to generate multiple target audio samples. Then, the server 130 determines one target audio sample from the multiple target audio samples in turn, adds a random mask to the target audio sample, and inputs it into the reference encoder 625.

After inputting the target audio sample into the reference encoder 625, the server 130 uses the reference encoder 625 to process the target audio sample to generate the sample semantic feature 630. In some embodiments, the reference encoder 625 may include a first linear layer, a transformer structure, and a second linear layer. As an example, multiple transformer structures may be provided, and input ends of the multiple transformer structures are connected to the first linear layer, and output ends of the multiple transformer structures are connected to the second linear layer. That is, the target audio sample is processed by the first linear layer, the multiple transformer structures, and the second linear layer in turn, and finally the sample semantic feature 630 is generated. The first linear layer may map the target audio sample to a vector space of a fixed dimension to convert it into a vector representation. The multiple transformer structures may extract semantic information or feature information. The second linear layer may convert outputs of the multiple transformer structures into a specific output format.

Further, for the case where the server 130 splits the reference audio sample 610 into multiple target audio samples, the multiple target audio samples are processed using the reference encoder 625, and multiple corresponding sample semantic features 630 may be generated. In this case, the server 130 may concatenate the multiple sample semantic features 630 to obtain the sample semantic feature 630 corresponding to the reference audio sample 610.

Additionally, the server 130 may further set a linear layer 470 connected to an output end of the reference encoder 625 to reduce the dimensionality of the output of the reference encoder 625, thereby obtaining the sample semantic feature 630. The linear layer 470 and the reference encoder 625 together form the semantic encoding model 620.

In some embodiments, the sample semantic feature 630 may indicate the semantic information of the reference audio sample 610. The semantic information may be, for example, a human cry, human speech, a bird chirping, a drumbeat, etc.

At block 520, the server 130 processes the sample semantic feature 630 using a reference decoder 640 to generate reference audio 650.

In some embodiments, the reference decoder 640 may include a third linear layer, a transformer structure, and a fourth linear layer. As an example, multiple transformer structures may also be provided here. Input ends of the multiple transformer structures are connected to the third linear layer, and output ends of the multiple transformer structures are connected to the fourth linear layer. That is, the sample semantic feature 630 is processed by the third linear layer, the multiple transformer structures, and the fourth linear layer in turn to generate the reference audio 650. The third linear layer may map the sample semantic feature 630 to a vector space to convert it into a corresponding vector representation. The multiple transformer structures may gradually generate a target sequence according to the vector representations. The fourth linear layer may convert the target sequence into a specific output format.

When the server 130 obtains the target sequence in the specific format, the server 130 may restore the target sequence to generate the reference audio 650.

Additionally, before processing the sample semantic feature 630 using the reference decoder 640, the server 130 may further set a linear layer connected to an input end of the reference decoder 640 to increase the dimensionality of the sample semantic feature 630.

At block 530, the server 130 determines a contrastive loss based on the reference audio 650 and the reference audio sample 610.

In some embodiments, the server 130 may first determine the difference between the reference audio 650 and the reference audio sample 610, and then determine the contrastive loss based on the difference between the reference audio 650 and the reference audio sample 610. As an example, the contrastive loss may be determined using the minimum absolute deviation.

At block 540, the server 130 trains the semantic encoding model 620 based on the contrastive loss.

In some embodiments, the server 130 may adjust the parameters of the semantic encoding model 620 by minimizing the training contrastive loss until the training converges.

In some embodiments, the server 130 may also select a model such as wavlm or hubert as the semantic encoding model 620.

Further, after completing the training of the semantic encoding model 620, the server 130 may use the semantic encoding model 620 to process the sample audio 410 to generate the reference semantic feature 475 in an inference process. In this case, the reference semantic feature 475 may accurately indicate the semantic information in the sample audio 410. The server 130 compares the sample mean representation 432 with the reference semantic feature 475, and may determine the difference between the sample mean representation 432 and the reference semantic feature 475, thereby determining the semantic loss. As an example, the semantic loss may be determined using the minimum absolute deviation.

At block 330, the server 130 determines a training loss of the audio encoder 420 based on the semantic loss, to train the audio encoder 420.

In some embodiments, the server 130 may train the audio encoder 420 based on the following steps: first, generating a sample encoding representation 440 of the sample audio 410 based on the sample mean representation 432 and the sample variance representation 434; then, determining a distribution loss based on the sample encoding representation 440 and a sample feature distribution corresponding to the sample mean representation 432 and the sample variance representation 434; and finally, determining the training loss based on the semantic loss and the distribution loss.

In the above process, the server 130 may resample the sample mean representation 432 and the sample variance representation 434 to generate the sample encoding representation 440. The sample feature distribution is the reference Gaussian distribution mentioned above, which is a Gaussian distribution indicated by the sample mean representation 432 and the sample variance representation 434. The server 130 may determine the distribution loss through the sample encoding representation 440 and the sample feature distribution. The distribution loss may indicate the similarity between the sample encoding representation 440 and the sample feature distribution.

Additionally, the server 130 may further determine another semantic loss based on the sample encoding representation 440 and the reference semantic feature 475, to further improve the semantic constraint on the encoding representation. The server 130 may determine the semantic loss using the minimum absolute deviation.

In some embodiments, the process of determining the training loss by the server 130 based on the semantic loss and the distribution loss may be as follows: first, processing the sample encoding representation 440 using the audio decoder 450 to generate predicted audio 455; then, determining a generation loss based on the predicted audio 455 and the sample audio 410; and finally, determining the training loss based on the semantic loss, the distribution loss, and the generation loss.

In the above process, the server 130 may use the audio decoder 450 to restore the sample encoding representation 440 to generate the predicted audio 455. As an example, the server 130 may determine the generation loss based on the similarity between the predicted audio 455 and the sample audio 410. The generation loss indicates the similarity between the predicted audio 455 and the sample audio 410.

Further, in some embodiments, the process of determining the training loss by the server 130 based on the semantic loss, the distribution loss, and the generation loss may be as follows: first, recognizing the predicted audio 455 using a discriminator 460 to generate a recognition result, wherein the recognition result indicates whether the predicted audio 455 is synthesized audio; then, determining a discriminative loss based on the recognition result; and finally, training the audio encoder 420 based on the semantic loss, the distribution loss, the generation loss, and the discriminative loss.

The server 130 sets the discriminator 460 to recognize the predicted audio 455, which may improve the realness of the audio generated based on the audio encoder 420 and the audio decoder 450. When using the semantic loss, the distribution loss, the generation loss, and the discriminative loss to train the audio encoder 420, the server 130 also needs to train the audio decoder 450 synchronously.

In some embodiments, the audio encoder and the semantic encoding model may correspond to the same feature encoding unit, that is, the structure for feature encoding in the audio encoder may be consistent with the structure for feature encoding in the semantic encoding model.

As an example, after completing the training of the semantic encoding model 620, the server 130 may apply the structure of the reference encoder 625 in the trained semantic encoding model 620 to the audio encoder 420, and apply the parameters of the trained reference encoder 625 to the audio encoder 420, and freeze the parameters at the same time. Meanwhile, the structure of the trained reference decoder 640 is applied to the audio decoder 450, and the parameters of the trained reference decoder 640 are applied to the audio decoder 450.

Specifically, when training the audio encoder 420 and the audio decoder 450, the server 130 may minimize the training semantic loss, the distribution loss, the generation loss, and the discriminative loss until the training converges, to complete the training of the audio encoder 420 and the audio decoder 450.

The encoding representation generated by the server 130 through the above process may have better semantic constraint and higher quality, so as to train a better machine learning model for audio restoration, thereby facilitating the improvement of the quality of the audio generated based on the audio encoder 420.

### Example Apparatus and Device

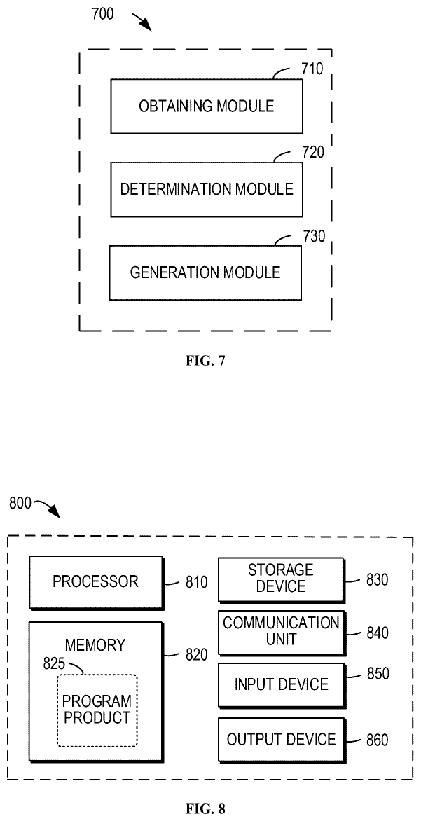

The embodiments of the present disclosure further provide corresponding apparatuses for implementing the above methods or processes. FIG. 7 is a schematic structural block diagram of an example apparatus 700 for audio encoding according to some embodiments of the present disclosure. The apparatus 700 may be implemented as or included in the electronic device 110. Each module/component in the apparatus 700 may be implemented by hardware, software, firmware, or any combination thereof.

As shown in FIG. 7, the apparatus 700 includes: an obtaining module 710 configured to obtain audio content; a determination module 720 configured to process the audio content using an audio encoder to determine a target mean representation and a target variance representation; and a generation module 730 configured to generate an encoding representation of the audio content based on the target mean representation and the target variance representation, where the audio encoder is trained based on a process including: processing sample audio using the audio encoder to determine a sample mean representation; determining a semantic loss based on the sample mean representation and a reference semantic feature of the sample audio; and determining a training loss of the audio encoder based on the semantic loss, to train the audio encoder.

In some embodiments, determining the training loss of the audio encoder based on the semantic loss includes: generating a sample encoding representation of the sample audio based on the sample mean representation and a sample variance representation, the sample variance representation being determined by processing the sample audio by the audio encoder; determining a distribution loss based on the sample encoding representation and a sample feature distribution corresponding to the sample mean representation and the sample variance representation, the distribution loss indicating the similarity between the sample encoding representation and the sample feature distribution; and determining the training loss based on the semantic loss and the distribution loss.

In some embodiments, determining the training loss based on the semantic loss and the distribution loss includes: processing the sample encoding representation using an audio decoder to generate predicted audio; determining a generation loss based on the predicted audio and the sample audio, the generation loss indicating the similarity between the predicted audio and the sample audio; and determining the training loss based on the semantic loss, the distribution loss, and the generation loss.

In some embodiments, determining the training loss based on the semantic loss, the distribution loss, and the generation loss includes: recognizing the predicted audio using a discriminator to generate a recognition result, the recognition result indicating whether the predicted audio is synthesized audio; determining a discriminative loss based on the recognition result; and training the audio encoder and the audio decoder based on the semantic loss, the distribution loss, the generation loss, and the discriminative loss.

In some embodiments, the reference semantic feature is generated by processing the sample audio using a semantic encoding model, where the semantic encoding model and the audio encoder correspond to the same feature encoding unit.

In some embodiments, the semantic encoding model is trained based on a process including: processing a reference audio sample using the semantic encoding model to generate a sample semantic feature; processing the sample semantic feature using a reference decoder to generate reference audio; determining a contrastive loss based on the reference audio and the reference audio sample; and training the semantic encoding model based on the contrastive loss.

In some embodiments, processing the reference audio sample using the semantic encoding model to generate the sample semantic feature includes: preprocessing the reference audio sample to generate a target audio sample; and processing the target audio sample using the semantic encoding model to generate the sample semantic feature.

In some embodiments, preprocessing the reference audio sample to generate the target audio sample includes: applying a mask to the reference audio sample to generate the target audio sample, the mask indicating that at least one segment of the reference audio sample is set to preset content.

In some embodiments, preprocessing the reference audio sample to generate the target audio sample includes: splitting the reference audio sample to generate multiple target audio samples.

As shown in FIG. 8, a computing device 800 is in the form of a general electronic device. Components of the computing device 800 may include, but are not limited to, one or more processors or processing units 810, a memory 820, a storage device 830, one or more communication units 840, one or more input devices 850, and one or more output devices 860. The processing unit 810 may be an actual or virtual processor and may perform various processes based on a program stored in the memory 820. In a multi-processor system, multiple processing units execute computer executable instructions in parallel to improve the parallel processing capability of the computing device 800.

The computing device 800 typically includes multiple computer storage medium. Such medium may be any available medium accessible to the computing device 800, including, but not limited to, volatile and non-volatile medium, and removable and non-removable medium. The memory 820 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 830 may be any removable or non-removable medium, and may include a machine-readable medium such as a flash drive, a disk, or any other medium, which may be used to store information and/or data and may be accessed within the computing device 800.

The computing device 800 may further include additional removable/non-removable, volatile/non-volatile memory medium. Although not shown in FIG. 8, a disk drive for reading from or writing to a removable, non-volatile disk (such as a “floppy disk”), and an optical disk drive for reading from or writing to a removable, non-volatile optical disk may be provided. In these cases, each drive may be connected to a bus (not shown) via one or more data medium interfaces. The memory 820 may include a computer program product 825, which has one or more program modules configured to perform various methods or acts of the various embodiments of the present disclosure.

The communication unit 840 enables communication with other electronic devices through the communication medium. Additionally, the functions of the components of the computing device 800 may be implemented by a single computing cluster or multiple computing machines, which may communicate through communication connections. Therefore, the computing device 800 may use a logical connection with one or more other servers, a network personal computer (PC), or another network node to operate in a networked environment.

The input device 850 may be one or more input devices, such as a mouse, a keyboard, a tracking ball, etc. The output device 860 may be one or more output devices, such as a display, a speaker, a printer, etc. The computing device 800 may also communicate with one or more external devices (not shown) as needed through the communication unit 840, the external devices such as a storage device, a display device, etc., communicate with one or more devices that enable the user to interact with the computing device 800, or communicate with any devices (for example, a network card, a modem, etc.) that enable the computing device 800 to communicate with one or more other electronic devices. Such communication may be performed via input/output (I/O) interfaces (not shown).

According to an example implementation of the present disclosure, a computer-readable storage medium is provided, which has computer executable instructions stored thereon, where the computer executable instructions are executed by a processor to implement the method described above. According to an example implementation of the present disclosure, there is further provided a computer program product, which is tangibly stored on a non-transitory computer-readable medium and includes computer executable instructions, and the computer executable instructions are executed by a processor to implement the method described above.

Various aspects of the present disclosure are described herein with reference to flowcharts and/or block diagrams of the method, the apparatus, the device, and the computer program product implemented according to the present disclosure. It should be understood that each block of the flowcharts and/or block diagrams, and a combination of the blocks in the flowcharts and/or block diagrams may be implemented by computer-readable program instructions.

These computer-readable program instructions may be provided to the processing unit of a general-purpose computer, a special-purpose computer, or other programmable data processing apparatus to produce a machine, so that when these instructions are executed by the processing unit of the computer or other programmable data processing apparatus, an apparatus that implements the functions/actions specified in one or more blocks in the flowcharts and/or block diagrams is produced. These computer-readable program instructions may also be stored in the computer-readable storage medium, and these instructions cause the computer, the programmable data processing apparatus, and/or other devices to work in a specific manner. Thus, the computer-readable medium storing the instructions includes a manufactured product, which includes instructions for implementing various aspects of the functions/actions specified in one or more blocks in the flowcharts and/or block diagrams.

The computer-readable program instructions may be loaded onto the computer, other programmable data processing apparatus, or other devices, so that a series of operations and steps are performed on the computer, other programmable data processing apparatus, or other devices to generate a computer-implemented process, so that the instructions executed on the computer, other programmable data processing apparatus, or other devices implement the functions/actions specified in one or more blocks in the flowcharts and/or block diagrams.

The flowcharts and block diagrams in the drawings show the possibly implemented architectures, functions, and operations of the system, the method, and the computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of the blocks in the block diagrams and/or flowcharts may be implemented by a special-purpose hardware-based system that executes specified functions or actions, or may be implemented by a combination of special-purpose hardware and computer instructions.

The implementations of the present disclosure have been described above, and the above description is illustrative, non-exhaustive, and not limited to the disclosed implementations. Without departing from the scope and spirit of the described implementations, many modifications and changes will be apparent to those of ordinary skill in the art. The terms used herein are selected to best explain the principles of the implementations, the actual applications or improvements to the technologies in the market, or to enable other persons of ordinary skill in the art to understand the implementations disclosed herein.

1. A method for audio encoding, comprising:
obtaining audio content;
processing the audio content using an audio encoder to determine a target mean representation and a target variance representation; and
generating an encoding representation of the audio content based on the target mean representation and the target variance representation, wherein the audio encoder is trained based on a process comprising:
processing sample audio using the audio encoder to determine a sample mean representation;
determining a semantic loss based on the sample mean representation and a reference semantic feature of the sample audio; and
determining a training loss of the audio encoder based on the semantic loss, to train the audio encoder.

2. The method of claim 1, wherein determining the training loss of the audio encoder based on the semantic loss comprises:
generating a sample encoding representation of the sample audio based on the sample mean representation and a sample variance representation, the sample variance representation being determined by processing the sample audio by the audio encoder;
determining a distribution loss based on the sample encoding representation and a sample feature distribution corresponding to the sample mean representation and the sample variance representation, the distribution loss indicating a similarity between the sample encoding representation and the sample feature distribution; and
determining the training loss based on the semantic loss and the distribution loss.

3. The method of claim 2, wherein determining the training loss based on the semantic loss and the distribution loss comprises:
processing the sample encoding representation using an audio decoder to generate predicted audio;
determining a generation loss based on the predicted audio and the sample audio, the generation loss indicating a similarity between the predicted audio and the sample audio; and
determining the training loss based on the semantic loss, the distribution loss, and the generation loss.

4. The method of claim 3, wherein determining the training loss based on the semantic loss, the distribution loss, and the generation loss comprises:
recognizing the predicted audio using a discriminator to generate a recognition result, the recognition result indicating whether the predicted audio is synthesized audio;
determining a discriminative loss based on the recognition result; and
training the audio encoder and the audio decoder based on the semantic loss, the distribution loss, the generation loss, and the discriminative loss.

5. The method of claim 1, wherein the reference semantic feature is generated by processing the sample audio using a semantic encoding model, wherein the semantic encoding model and the audio encoder correspond to a same feature encoding unit.

6. The method of claim 5, wherein the semantic encoding model is trained based on a process comprising:
processing a reference audio sample using the semantic encoding model to generate a sample semantic feature;
processing the sample semantic feature using a reference decoder to generate reference audio;
determining a contrastive loss based on the reference audio and the reference audio sample; and
training the semantic encoding model based on the contrastive loss.

7. The method of claim 6, wherein processing the reference audio sample using the semantic encoding model to generate the sample semantic feature comprises:
preprocessing the reference audio sample to generate a target audio sample; and
processing the target audio sample using the semantic encoding model to generate the sample semantic feature.

8. The method of claim 7, wherein preprocessing the reference audio sample to generate the target audio sample comprises:
applying a mask to the reference audio sample to generate the target audio sample, the mask indicating that at least one segment of the reference audio sample is set to preset content.

9. The method of claim 7, wherein preprocessing the reference audio sample to generate the target audio sample comprises:
splitting the reference audio sample to generate a plurality of the target audio samples.

10. A computing device, comprising:
at least one processing unit; and
at least one memory coupled to the at least one processing unit and storing instructions for execution by the at least one processing unit, the instructions, when executed by the at least one processing unit, causing the computing device to perform operations comprising:
obtaining audio content;
processing the audio content using an audio encoder to determine a target mean representation and a target variance representation; and
generating an encoding representation of the audio content based on the target mean representation and the target variance representation, wherein the audio encoder is trained based on a process comprising:
processing sample audio using the audio encoder to determine a sample mean representation;
determining a semantic loss based on the sample mean representation and a reference semantic feature of the sample audio; and
determining a training loss of the audio encoder based on the semantic loss, to train the audio encoder.

11. The computing device of claim 10, wherein determining the training loss of the audio encoder based on the semantic loss comprises:
generating a sample encoding representation of the sample audio based on the sample mean representation and a sample variance representation, the sample variance representation being determined by processing the sample audio by the audio encoder;
determining a distribution loss based on the sample encoding representation and a sample feature distribution corresponding to the sample mean representation and the sample variance representation, the distribution loss indicating a similarity between the sample encoding representation and the sample feature distribution; and
determining the training loss based on the semantic loss and the distribution loss.

12. The computing device of claim 11, wherein determining the training loss based on the semantic loss and the distribution loss comprises:
processing the sample encoding representation using an audio decoder to generate predicted audio;
determining a generation loss based on the predicted audio and the sample audio, the generation loss indicating a similarity between the predicted audio and the sample audio; and
determining the training loss based on the semantic loss, the distribution loss, and the generation loss.

13. The computing device of claim 12, wherein determining the training loss based on the semantic loss, the distribution loss, and the generation loss comprises:
recognizing the predicted audio using a discriminator to generate a recognition result, the recognition result indicating whether the predicted audio is synthesized audio;
determining a discriminative loss based on the recognition result; and
training the audio encoder and the audio decoder based on the semantic loss, the distribution loss, the generation loss, and the discriminative loss.

14. The computing device of claim 10, wherein the reference semantic feature is generated by processing the sample audio using a semantic encoding model, wherein the semantic encoding model and the audio encoder correspond to a same feature encoding unit.

15. The computing device of claim 14, wherein the semantic encoding model is trained based on a process comprising:
processing a reference audio sample using the semantic encoding model to generate a sample semantic feature;
processing the sample semantic feature using a reference decoder to generate reference audio;
determining a contrastive loss based on the reference audio and the reference audio sample; and
training the semantic encoding model based on the contrastive loss.

16. The computing device of claim 15, wherein processing the reference audio sample using the semantic encoding model to generate the sample semantic feature comprises:
preprocessing the reference audio sample to generate a target audio sample; and
processing the target audio sample using the semantic encoding model to generate the sample semantic feature.

17. The computing device of claim 16, wherein preprocessing the reference audio sample to generate the target audio sample comprises:
applying a mask to the reference audio sample to generate the target audio sample, the mask indicating that at least one segment of the reference audio sample is set to preset content.

18. The computing device of claim 16, wherein preprocessing the reference audio sample to generate the target audio sample comprises:
splitting the reference audio sample to generate a plurality of the target audio samples.

19. A non-transitory computer-readable storage medium having stored thereon a computer program executable by a processor to implement operations comprising:
obtaining audio content;
processing the audio content using an audio encoder to determine a target mean representation and a target variance representation; and
generating an encoding representation of the audio content based on the target mean representation and the target variance representation, wherein the audio encoder is trained based on a process comprising:
processing sample audio using the audio encoder to determine a sample mean representation;
determining a semantic loss based on the sample mean representation and a reference semantic feature of the sample audio; and
determining a training loss of the audio encoder based on the semantic loss, to train the audio encoder.

20. The non-transitory computer-readable storage medium of claim 19, wherein determining the training loss of the audio encoder based on the semantic loss comprises:
generating a sample encoding representation of the sample audio based on the sample mean representation and a sample variance representation, the sample variance representation being determined by processing the sample audio by the audio encoder;
determining a distribution loss based on the sample encoding representation and a sample feature distribution corresponding to the sample mean representation and the sample variance representation, the distribution loss indicating a similarity between the sample encoding representation and the sample feature distribution; and
determining the training loss based on the semantic loss and the distribution loss.
